(19) United States
(12) Patent Application Publication
(10) Pub. No.: US 2023/0011249 A1
(43) Pub. Date: Jan. 12, 2023

(54) PET TOY

(71) Applicant: SPARKLE DESIGN LTD., Taipei City (TW)

(72) Inventors: Yun-Pei LEE, Taipei City (TW); Tsung-Cheng SHIH, New Taipei City (TW)

(21) Appl. No.: 17/861,695

(22) Filed: Jul. 11, 2022

(30) Foreign Application Priority Data
Jul. 12, 2021 (TW) 110208169

(51) Int. Cl. A01K 15/02

(52) U.S. Cl. CPC A01K 15/025

(57) ABSTRACT

A pet toy includes a bar and a hollow casing. The bar includes a first-end portion and a second-end portion. The hollow casing is mounted to the first end portion. The hollow casing has an internal wall that defines an accommodation space. The hollow casing includes multiple apertures in communication with the accommodation space. The pet toy is applicable to the interaction between an owner and a pet and is also suitable for being played by the pet itself.

### FIELD OF THE INVENTION

The present invention relates to a toy for pets, and more particular to a pet toy for interaction between a pet owner and a pet and also for the pet to play by itself.

### BACKGROUND OF THE INVENTION

The number of pet owners and their pets are both significantly increased recently. A variety of articles and services for pets are hence emerging. In addition to feeds, toys, and cleaning products for pets, there are also new types of services, such as pet grooming, pet sitting, pet hotels, and pet nursing, which are not common before.

Besides feeding and keeping sanitary and healthy, some owners pay much attention to interaction and communication with their pets. Many pets play an important role in the owners' emotions and lives and are very close to the family. As such, many pet owners wish to have proper toys for them to interact with the pets they keep and also to keep the pets busy and behavior well when the owners are out, in order to keep pets being energetic and healthy.

### SUMMARY OF THE INVENTION

To achieve the above purpose, the present invention aims to provide a pet toy that also demonstrates enhanced industrial utilization.

The technical solution adopted in the present invention provides a pet toy, which comprises: a bar, which comprises a first end portion and a second end portion; and a hollow casing, which is mounted to the first end portion, the hollow casing having an internal wall that delimits an accommodation space, the hollow casing being formed with multiple apertures in communication with the accommodation space.

In an implementing example of the pet toy according to the present invention, the hollow casing is mounted to the bar in a detachable manner.

In an implementing example of the pet toy according to the present invention, the hollow casing is formed of a first casing part and a second casing part detachably combinable with each other and an internal wall of the first casing part and an internal wall of the second casing part jointly define the accommodation space after the combination of the first casing part and the second casing part.

In an implementing example of the pet toy according to the present invention, the first casing part has an outside surface that is provided with a plurality of retaining protrusions, and the second casing part is provided with a retaining recess formed in the internal wall thereof, wherein the retaining protrusions and the retaining recess are engageable with and retained to each other; and the first casing part and the second casing part are each provided with multiple ones of the apertures, and a conic shell is formed on the internal wall of the second casing part, such that the conic shell circumferentially defines an opening, the opening being in communication with the multiple ones of the apertures provided in the second casing part.

In an implementing example of the pet toy according to the present invention, the hollow casing has an outside shape of the sphere.

In an implementing example of the pet toy according to the present invention, the first end portion comprises a holding ring, and the hollow casing is formed, in an outside surface thereof, with a retaining recess, the hollow casing being detachably mounted to the holding ring by means of the retaining recess.

In an implementing example of the pet toy according to the present invention, the holding ring is provided with a plurality of protrusions.

In an implementing example of the pet toy according to the present invention, the second end portion comprises a hanging portion.

In an implementing example of the pet toy according to the present invention, the accommodation space receives therein catnip or silver vine.

In an implementing example of the pet toy according to the present invention, the accommodation space receives therein a bell.

In an implementing example of the pet toy according to the present invention, the bar has a length of 15 to 25 centimeters.

In an implementing example of the pet toy according to the present invention, the bar and the hollow casing are each made of food-grade silicone rubber.

The pet toy according to the present invention comprises a bar and a hollow casing. The hollow casing may receive various articles or objects placed in an accommodation space thereof to attract the pet to play and to enhance an effect and diversification of interaction between the owner and the pet. In an embodiment, the bar is provided with a hanging portion to allow the owner to fit over a hand for swinging and interacting with the pet or to hang on a wall or an edge of a table for flapping and playing by the pet. In another embodiment, the hollow casing is mounted to the bar in a detachable manner, so that the hollow casing and the bar are separable from each other to each serve as an individual toy for the pet.

The pet toy according to the present invention features multiple practical uses, allowing easy interaction and playing between the owner and the pet or allowing the pet to play by itself, this being particularly suitable for playing with an old pet cat in a gentle way to increase the activity of the cat.

### BRIEF DESCRIPTION OF THE DRAWINGS

FIG. 1 is a schematic view showing a pet toy according to an embodiment of the present invention;

FIG. 2A is a view showing an outside appearance of a hollow casing for an implementing example of the pet toy according to the present invention;

FIG. 2B is a view showing an implementing example of a hollow casing composed of two casing parts;

FIG. 2C is a cross-sectional view showing the two casing parts of FIG. 2B;

FIG. 2D is a schematic view showing a holding ring and protrusions of the pet toy according to the present invention;

FIG. 3A is a schematic view showing the pet toy of the present invention hung on a wall for a cat to play;

FIG. 3B is a schematic view showing the pet toy of the present invention hung on an edge of a table for a cat to play; and

FIG. 3C is a schematic view showing a hollow casing and a bar the pet toy according to the present invention are separated to be individually played by a cat.

### DETAILED DESCRIPTION OF THE PREFERRED EMBODIMENTS

A detailed description and technical contents of the present invention will be explained hereinafter with reference to the drawings. However, it is noted that the drawings are provided for reference and illustration with the intention to help understand the present invention, not to limit the scope of the present invention.

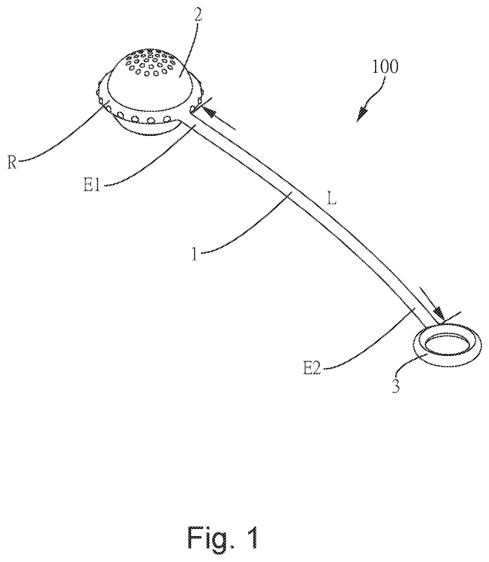

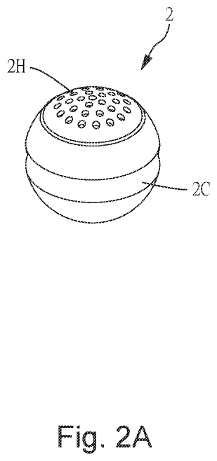

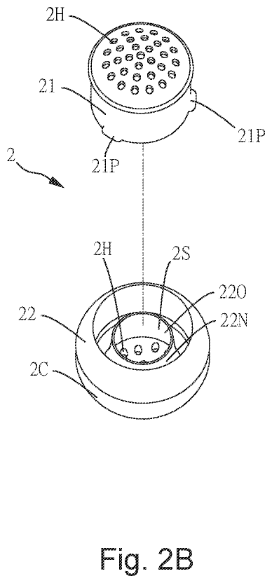

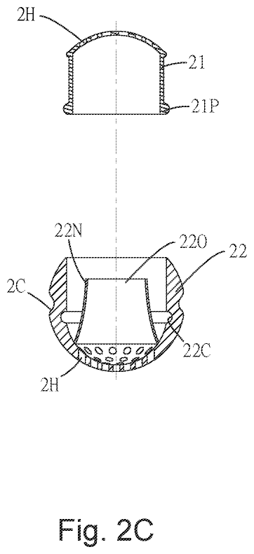

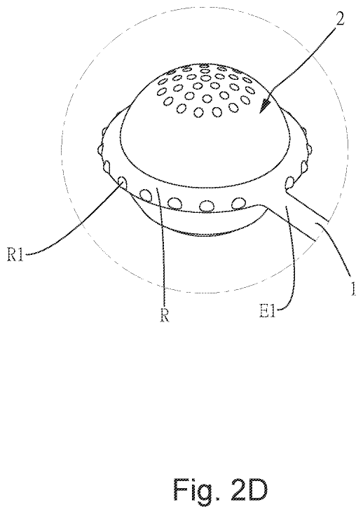

Firstly, reference being had to FIGS. 1 and 2A, an implementing example of a pet toy according to the present invention is disclosed. The pet toy 100 comprises: a bar 1 and a hollow casing or shell 2. The bar 1 and the hollow casing 2 are made of materials of food-grade silicone certified by the Food and Drug Administration (FDA). An example of the pet as discussed in the disclosure is a cat, yet the pet toy 100 is also applicable to use with other suitable pets.

The bar 1 includes a first end portion E1 and a second end portion E2. The hollow casing 2 is arranged at the first end portion E1 of the bar 1. The second end portion E2 is to be gripped by an owner for shaking and swaying the pet toy 100 to interest the pet cat to play or grab and bit. The bar 1 has a length L that is approximately 15-25 centimeters, suitable for playing by the pawls and mouth of the cat for biting and hitting simultaneously.

The hollow casing 2 has an internal wall that delimits and defines an accommodation space 2S. The hollow casing 2 includes multiple apertures 2H that are in communication with the accommodation space 2S. The accommodation space 2S formed in the interior of the hollow casing 2 may allow the owner to place and substitute different articles therein according to the preferences of the pet, in order to enhance the effect of interaction with the pet and diversification. For example, an owner who keeps a cat may place plants, such as catnip and silver vine, which interests and excites the cat in the accommodation space 2S, so that the smells of such plants may spread out through the apertures 2H, and powders of such plants may cast out through the apertures 2H during playing by the cat to be eaten by the cat. The owner may also place a bell in the accommodation space 2S to give off sounds for attracting the attention of the cat.

In an embodiment, as shown in FIGS. 2B and 2C, the hollow casing 2 is formed by combining a first casing part 21 and a second casing part 22 in a detachable manner. An internal wall of the first casing part 21 and an internal wall of the second casing part 22 jointly delimit and define the accommodation space 2S after the combination of the first casing part 21 and the second casing part 22. An outside surface of the first casing part 21 is provided with a plurality of retaining protrusions 21P, which are engageable with and retained in a retaining recess 22C formed in the internal wall of the second casing part 22. Combining the first casing part 21 and the second casing part 22 may be implemented with other feasible structures and ways. The first casing part 21 and the second casing part 22 are each provided with multiple ones of the apertures 2H. In an embodiment, a bottom part of the internal wall of the second casing part 22 is provided with a conic shell 22N arranged thereon. The conic shell 22N circumferentially delimits and defines an opening 22O, and the opening 22O is in communication with the ones of the apertures 2H that are formed in the second casing part 22. The plant powder or the bell that was mentioned previously may be collectively placed in the space surrounded by the conic shell 22N.

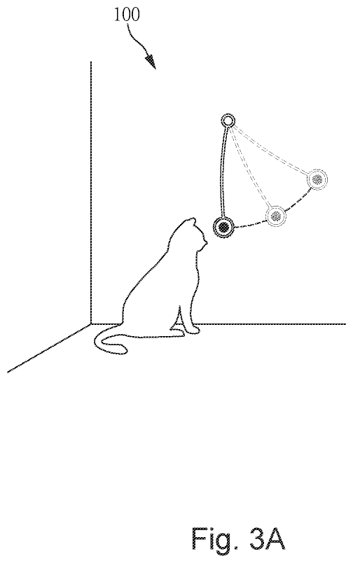

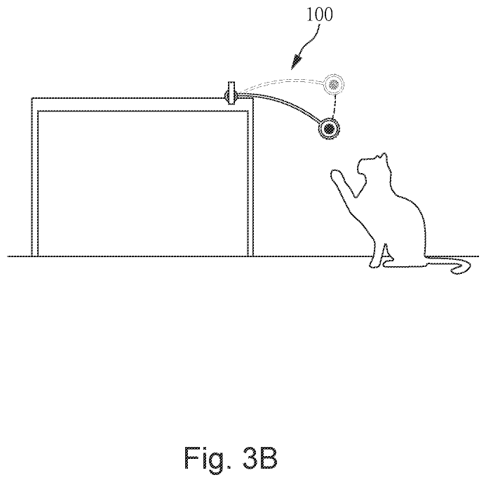

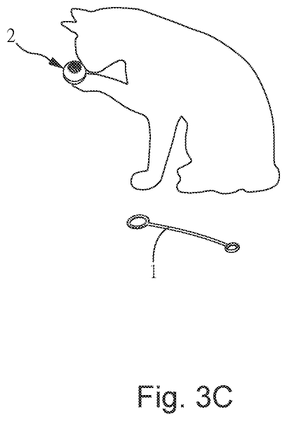

Optionally, the second end portion E2 of the bar 1 is provided with a hanging portion 3, which may receive a finger of the owner to inert therein for holding and swinging to play with the pet cat. Further, the pet toy 100 may be hung on for example a wall or an edge of a table by means of the hanging portion 3 to allow the pet cat to flap and play with itself, as illustrated in FIGS. 3A and 3B.

In one embodiment, the hollow casing 2 is detachably attached to the bar 1. As shown in FIGS. 2A and 2D, in the instant embodiment, the first end portion E1 of the bar 1 includes a holding ring R, and the hollow casing 2 is provided, on an outside surface thereof, with a retaining recess 2C, so that the hollow casing 2 is detachably mounted, with the retaining recess 2C thereof, to the holding ring R. The hollow casing 2 may be attached and fixed to the bar 1 by other feasible ways. Further, the holding ring R is provided with a plurality of protrusions R1, and the protrusions R1 may help cleans the teeth of the cat when the cat bites the holding ring R and the hollow casing 2. The hollow casing 2 and the bar 1 are detachable from each other to each separately serve as an individual toy for the cat. Also, the hollow casing 2 provides an effect of tooth cleansing when the cat bites the hollow casing 2, as shown in FIG. 3C. In the instant embodiment, the hollow casing 2 is the shape of the sphere, making it easy to roll, after being detached, for chasing and playing by the pet. The hollow casing 2 may also be structured as other suitable shapes.

The description provided above is only concerned with the preferred embodiments of the present invention and is not intended to limit the scope of implementation of the present invention as defined in the claims. Equivalent alterations in respect of structures that are made according to the contents of the specification and the drawings of the present invention should be considered equally falling within the scope of the present invention defined by the claims.

What is claimed is:

1. A pet toy, comprising:
a bar, which comprises a first end portion and a second end portion; and
a hollow casing, which is mounted to the first end portion, the hollow casing having an internal wall that delimits an accommodation space, the hollow casing being formed with multiple apertures in communication with the accommodation space.

2. The pet toy according to claim 1, wherein the hollow casing is mounted to the bar in a detachable manner.

3. The pet toy according to claim. 1, wherein the hollow casing is formed of a first casing part and a second casing part detachably combinable with each other and an internal wall of the first casing part and an internal wall of the second casing part jointly define the accommodation space after the combination of the first casing part and the second casing part.

4. The pet toy according to claim. 3, wherein the first casing part has an outside surface that is provided with a plurality of retaining protrusions, and the second casing part is provided with a retaining recess formed in the internal wall thereof, wherein the retaining protrusions and the retaining recess are engageable with and retained to each other; and the first casing part and the second casing part are each provided with multiple ones of the apertures, and a conic shell is formed on the internal wall of the second casing part, such that the conic shell circumferentially defines an opening, the opening being in communication with the multiple ones of the apertures provided in the second casing part.

5. The pet toy according to claim 1, wherein the hollow casing has an outside shape of the sphere.

6. The pet toy according to claim 5, wherein the first end portion comprises a holding ring, and the hollow casing is formed, in an outside surface thereof, with a retaining recess, the hollow casing being detachably mounted to the holding ring by means of the retaining recess.

7. The pet toy according to claim 6, wherein the holding ring is provided with a plurality of protrusions.

8. The pet toy according to claim 1, wherein the second end portion comprises a hanging portion.

9. The pet toy according to claim 1, wherein the accommodation space receives therein catnip or silver vine.

10. The pet toy according to claim 1, wherein the accommodation space receives therein a bell.

11. The pet toy according to claim 1, wherein the bar has a length of 15 to 25 centimeters.

12. The pet toy according to claim 1, wherein the bar and the hollow casing are each made of food-grade silicone rubber.
